(19) United States
(12) Patent Application Publication
(10) Pub. No.: US 2026/0215399 A1
(43) Pub. Date: Jul. 30, 2026

(54) INTELLIGENT PET CARE METHOD,SYSTEM,DEVICE AND MEDIUM

(71) Applicants: Wenjin Feng, Shenzhen (CN); Junyong Zhang, Shenzhen (CN)

(72) Inventors: Wenjin Feng, Shenzhen (CN); Junyong Zhang, Shenzhen (CN)

(21) Appl. No.: 19/031,455

(22) Filed: Jan. 18, 2025

Related U.S. Application Data
(63) Continuation of application No. PCT/CN2024/114913, filed on Aug. 27, 2024.

(51) Int. Cl. A01K 29/00; G06V 40/10; G10L 15/08; G10L 15/18

(52) U.S. Cl. CPC A01K 29/007; G06V 40/10; G10L 15/1815; G10L 2015/088

(57) ABSTRACT

The present disclosure discloses an intelligent pet care method, system, device and medium, the method comprises: receiving a first control instruction, querying according to the first control instruction to acquire pet information; converting the pet information into audio and playing the audio; wherein the first control instruction comprises a unique identifier of the pet. The intelligent pet care method provided according to the present disclosure is provided on the intelligent pet care device in a dog-keeping space, and it is used to receive the first control instruction input by the user, and query the pet information according to the first control instruction and then convert the pet information into audio to be played.

### CROSS-REFERENCE TO RELATED APPLICATIONS

This application is a national application of PCT/CN2024/114913, filed on Aug. 27, 2024. The contents of PCT/CN2024/114913 are all hereby incorporated by reference.

### TECHNICAL FIELD

The present disclosure relates to the technical field of pets, and in particular, relates to an intelligent pet care method, system, device and medium.

### BACKGROUND

With the development of society and the acceleration of pace of life, many pet owners are unable to take care of their pets all the time because of their busy work. Therefore, there is an increasing demand for devices that can automatically complete pet feeding, cleaning and interaction functions. Furthermore, the main functions of the existing pet management devices are all customized for specific scenarios, so health and behaviors of pets cannot be comprehensively managed. Moreover, it is impossible for pet owners to rapidly and conveniently know the conditions of their pets anytime and anywhere. Therefore, there is an urgent need for an intelligent device that can fully care for the health and behaviors of pets, so that pet owners can more conveniently know various conditions of their pets to make timely judgments and responses.

### SUMMARY

The present disclosure provides an intelligent pet care method, system, device and medium, which can realize real-time monitoring of pets and timely broadcasting of relevant information of pets, so that pet owners can more conveniently know the conditions of their pets to make timely judgments and responses.

A first aspect of the present disclosure provides an intelligent pet care method, which comprises the following steps:
receiving a first control instruction, and querying according to the first control instruction to acquire pet information;
converting the pet information into audio and playing the audio;
wherein the first control instruction comprises a unique identifier of the pet.

The step of querying according to the first control instruction to acquire pet information includes one of the following querying modes: querying the stored data locally, querying the remotely stored data from a remote server, and sending an instruction to other pet devices to query the real-time data.

The pet information includes key data of the pet in a specific time interval, and the step of receiving the first control instruction further comprises: extracting keywords after semantic analysis according to the first control instruction, and then calculating according to the keywords to acquire the specific time interval.

The pet information includes one of the following: pet feeding data, pet defecation data and pet calling data.

The intelligent pet care method further comprises the step of:
carrying out pet calling statistics to form and store the pet calling data.

The pet calling statistics further comprises the steps of:
performing sound detection to acquire the sound of the pet; and
performing AI analysis on the sound of the pet to acquire the pet calling data.

The pet calling statistics further comprises the steps of:
recording a video to acquire the video of the pet; and
performing AI analysis on the video of the pet to acquire the pet calling data.

The intelligent pet care method further comprises the step of:
carrying out pet defecation statistics to form and store the pet defecation data.

The pet defecation statistics further comprises the steps of:
recording a video to acquire the video of the pet; and
performing AI analysis on the video of the pet to acquire the pet defecation data.

The pet defecation statistics further comprises the step of:
communicating with a pet device to acquire the defecation data of the pet, wherein the pet device includes a device worn on the pet and a defecation device.

The intelligent pet care method further comprises the step of:
carrying out pet feeding statistics to form and store the pet feeding data.

The pet feeding statistics further comprises the step of:
communicating with a pet device to acquire the feeding data of the pet, wherein the pet device includes a device worn on the pet, a feeder and a water feeder.

The intelligent pet care method further comprises the steps of:
receiving a second control instruction, and sending second control information to the position where the pet is located according to the second control instruction;
the second control information is sent by one of the following: voice, light and projection;
wherein the second control instruction comprises a unique identifier of the pet.

The step of sending second control information to the position where the pet is located according to the second control instruction further comprises the steps of:
starting position detection for the pet, calculating to determine the position of the pet according to the result of the position detection for the pet, and recording and storing the change trajectory of the position.

The intelligent pet care method further comprises the steps of:
receiving a third control instruction and sending third control information to a pet device according to the third control instruction;
the third control information is sent by one of the following: infrared, radio frequency and Bluetooth;
wherein the third control instruction comprises a unique identifier of the pet device.

The control instruction is input by one of the following: voice input, camera-captured picture input, touch screen input, mechanical key input and remote communication input.

In another aspect, the present disclosure provides an intelligent pet care device, which comprises:
an instruction receiving module, an instruction sending module, a central control module, an AI analysis module, a voice interaction module and a storage module; wherein the instruction receiving module is configured to receive control instructions; the instruction sending module is configured to send control information; the storage module is configured to store pet information and/or audio and video information about interaction with the pet; the AI analysis module is configured to perform AI analysis according to the input original data so as to acquire pet information; the voice interaction module is configured to convert the pet information into audio and play the audio, and the central control module is configured to control the cooperation among the instruction receiving module, the instruction sending module, the AI analysis module, the voice interaction module and the storage module.

In a further aspect, the present disclosure provides an intelligent pet care device, which comprises a memory and a processor coupled to each other, wherein the processor is configured to execute program instructions stored in the memory so as to implement the intelligent pet care method according to any of the aforesaid items.

In yet another aspect, the present disclosure provides an intelligent pet care system, which comprises a pet device and the aforesaid intelligent pet care device.

In a further aspect, the present disclosure provides a computer-readable storage medium having program instructions stored thereon, the program instructions, when executed by a processor, implement the intelligent pet care method according to any of the aforesaid items.

The present disclosure has the following beneficial effects: the intelligent pet care method provided according to the present disclosure is provided on the intelligent pet care device in a dog-keeping space, and it is used to receive the first control instruction, and query according to the first control instruction to acquire the pet information, and then convert the pet information into audio to be played. In this way, users (e.g., pet owners, breeders or the like) can immediately know various conditions of their pets without turning on their mobile phones or carrying out complicated network operations, so as to make timely judgments and responses and improve the convenience and accuracy of acquiring pet information by users.

### BRIEF DESCRIPTION OF THE DRAWINGS

The accompanying drawings herein, which are incorporated in and constitute a part of this specification, illustrate embodiments in accordance with the present disclosure and, together with the specification, serve to explain technical solutions of the present disclosure.

FIG. 1 is a schematic flowchart diagram of an embodiment of an intelligent pet care method provided according to the present disclosure.

FIG. 2 is a schematic flowchart diagram of another embodiment of the intelligent pet care method provided according to the present disclosure.

FIG. 3 is a schematic flowchart diagram of yet another embodiment of the intelligent pet care method provided according to the present disclosure.

FIG. 4 is a schematic scenario diagram of an embodiment of an intelligent pet care system provided according to the present disclosure.

FIG. 5 is a schematic scenario diagram of another embodiment of the intelligent pet care system provided according to the present disclosure.

FIG. 6 is a schematic frame diagram of an embodiment of an intelligent pet care device provided according to the present disclosure.

FIG. 7 is a schematic view for signaling interaction of an embodiment of an intelligent pet care system provided according to the present disclosure.

FIG. 8 is a schematic view for signaling interaction of another embodiment of the intelligent pet care system provided according to the present disclosure.

FIG. 9 is a schematic view for signaling interaction of yet another embodiment of the intelligent pet care system provided according to the present disclosure.

FIG. 10 is a schematic frame diagram of an embodiment of an intelligent pet care device provided according to the present disclosure.

FIG. 11 is a schematic frame diagram of an embodiment of a computer-readable storage medium provided according to the present disclosure.

### DETAILED DESCRIPTION

Hereinafter, solutions of embodiments of the present disclosure will be described in detail with reference to the attached drawings of the specification.

In the following description, for the purpose of explanation rather than limitation, specific details such as specific system architectures, interfaces and technologies are set forth in order to thoroughly understand the present disclosure.

Herein, the term “and/or” is only used to describe association relationships among associated objects, and it means that there may be three kinds of relationships among the associated objects. For example, A and/or B may represent the following three cases: A alone, both A and B, and B alone. In addition, the character “/” used herein generally indicates that the associated objects before and after the character “/” are in an “or” relationship. In addition, “multiple” used herein means two or more. Additionally, the term “at least one” used herein means any one or any combination of at least two of multiple items. For example, at least one of A, B and C being included may mean that any one or more elements selected from the set of A, B and C is included.

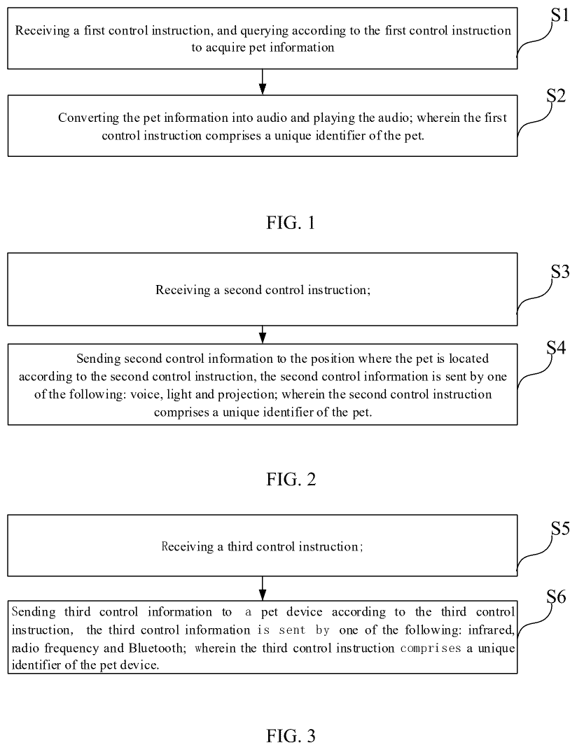

Referring to FIG. 1, there is shown a schematic flowchart diagram of an embodiment of an intelligent pet care method provided according to the present disclosure.

As shown in FIG. 1, a first aspect of the present disclosure provides an intelligent pet care method, which comprises the following steps:
S1: receiving a first control instruction, and querying according to the first control instruction to acquire pet information;
S2: converting the pet information into audio and playing the audio;
wherein the first control instruction comprises a unique identifier of the pet.

The present method may be run on an intelligent pet care device arranged in a dog-keeping space, and the intelligent pet care device can receive the control instruction input by the user and respond in time.

A typical scenario is as follows:
when the pet owner came back home, he/she asked the intelligent pet care device: “How many times did my dog eat dog food today?” “How much dog food is left?” The intelligent pet care device answered by voice: “Your dog ate three meals of dog food today, with a total of 30% dog food left.”

As can be seen from the above description, the solution of the present disclosure enables the users (e.g., the pet owners) to know the pet information that day simply by querying with voice without turning on their mobile phones or opening the feeder to check, so that users can know the conditions conveniently and accurately to make timely responses.

The step of querying according to the first control instruction to acquire pet information includes one of the following querying modes: querying the stored data locally, querying the remotely stored data from a remote server, and sending an instruction to other pet devices to query the real-time data.

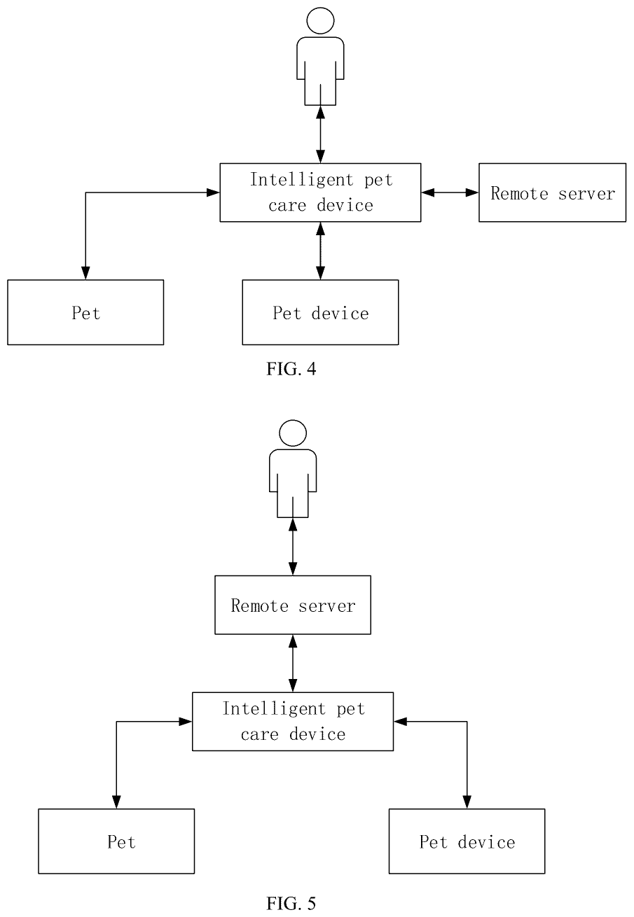

Specifically, referring to FIG. 4 and FIG. 5, there are shown schematic scenario diagrams of an embodiment of an intelligent pet care system provided according to the present disclosure.

The remote server may be deployed in the computer room of the user, or deployed at the remote cloud, specifically depending on the usage scenario and cost of the user.

The user may interact with the intelligent pet care device directly (FIG. 4) or interact with the intelligent pet care device through a remote server (FIG. 5). If the interactive mode shown in FIG. 5 is adopted, then the user may also connect various terminals to the intelligent pet care device, and the terminals include but not limited to: mobile terminals such as mobile phones and notebook computers, and fixed terminals such as desktop computers or other intelligent devices. In this way, the users can view the conditions of their pets remotely in various environments to control the pet device even if the users are not at home or in the pet room, thereby achieving the purpose of remote care and interaction.

The intelligent pet care device can access the network in the wired or wireless manner so as to communicate with the remote server. The intelligent pet care device may also be provided with one or more monitoring cameras, which may be installed at the top, at the side and partially arranged to be rotatable or slidable.

The pet information comprises key data of the pet in a specific time interval, and the step of receiving the first control instruction further comprises: extracting keywords after semantic analysis according to the first control instruction, and then calculating according to the keywords to acquire the specific time interval. For example, if the pet owner asks the intelligent pet care device: “What did the dog eat in the morning?”, then the specific time interval acquired by calculation is 7-9 a.m., and the algorithm of this time interval may be preset or updated iteratively accord to empirical values.

Specifically, semantic analysis also includes detecting and saving the voice input information of relevant users, conducting AI training and analysis, and then automatically matching the monitoring data for 1-2 days after the users input new control instructions so as to acquire the specific time interval, without the need for the pet owner to design accurate queries. For example, when the owner says “how's the dog recently?”, the “recently” can be automatically matched to be within 2 days according to the voice input habit of the user.

The pet information includes one of the following: pet feeding data, pet defecation data, pet calling data, pet health data and pet mood data. The feeding data includes dog food feeding, snacks feeding and water drinking or the like recorded in real time. The pet defecation data includes defecation recorded in real time. The pet calling data includes times, frequency, sound volume, consistency or the like of the calling recorded in real time. From these data, we can simply infer the physical health of the pets, and can also further infer the emotional changes of the pets by combining the AI algorithm. Further speaking, the pet information may also include physical indicators, heartbeat data or the like.

The method further comprises the following step of: carrying out pet calling statistics to form and store pet calling data. The pet calling data may be stored locally or uploaded to a remote server.

The pet calling statistics further comprises the steps of: performing sound detection to acquire the sound of the pet; and performing AI analysis on the sound of the pet to acquire the pet calling data. The sound detection may be carried out by a sound detection device locally arranged in the intelligent pet care device, or it may be acquired by sending an instruction to the pet device worn on the pet. For example, the pet device may be a smart collar with a radio receiver that is worn by the dog.

The pet calling statistics further comprises the steps of: recording a video to acquire the video of the pet; and performing AI analysis on the video of the pet to acquire the pet calling data. The video recording may be carried out through the locally arranged monitoring camera of the intelligent pet care device, or the video may be captured by sending instructions to the pet device worn by the pet. For example, the pet device may be a smart collar with a camera device that is worn by the dog.

The method further comprises the following step of: carrying out pet defecation statistics to form and store the pet defecation data.

The pet defecation statistics further comprises the steps of: recording a video to acquire the video of the pet; and performing AI analysis on the video of the pet to acquire the pet defecation data.

The pet defecation statistics further comprises the step of: communicating with a pet device to acquire the defecation data of the pet, wherein the pet device includes a device worn on the pet and a defecation device.

The method further comprises the step of: carrying out pet feeding statistics to form and store the pet feeding data.

The pet feeding statistics further comprises the step of: communicating with a pet device to acquire the feeding data of the pet, wherein the pet device includes a device worn on the pet, a feeder and a water feeder.

Referring to FIG. 7, there is shown a schematic view for signaling interaction of an embodiment of an intelligent pet care system provided according to the present disclosure, which specifically includes the following steps:
1. performing the above-mentioned sound detection or video recording on pets by the intelligent pet care device, and storing the acquired pet data locally and remotely;
2. inputting a first control instruction to the intelligent pet care device by the user;
3. querying relevant pet data in various ways by the intelligent pet care device, including local querying, querying to the pet device, querying to the remote server or the like;
4. performing AI analysis according to the querying results to acquire pet information; and
5. converting the pet information into voice for broadcasting.

The monitoring data mentioned in the above embodiment include audio and video data, and in addition, it may also include all detectable data related to the dog itself and the living environment of the dog. The data may be saved to the intelligent pet care device or transmitted to the remote terminal for subsequent AI analysis and reuse.

The control instruction is input by one of the following: voice input, camera-captured picture input, touch screen input, mechanical key input and remote communication input. The specific way may be selected according to the setting of the intelligent pet care device.

Referring to FIG. 2, the method further comprises the following steps:
S3: receiving a second control instruction; and
S4: sending second control information to the position where the pet is located according to the second control instruction;
the second control information is sent by one of the following: voice, light and projection;
wherein the second control instruction comprises a unique identifier of the pet.

In this way, multiple interactions with pets can be realized, thereby achieving the effect of intelligent companionship.

The operation of sending second control information to the position where the pet is located according to the second control instruction further comprises the steps of:
starting position detection for the pet, calculating to determine the position of the pet according to the result of the position detection for the pet, and recording and storing the change trajectory of the position.

In this way, the position of the pet can be accurately locked, the accuracy of interaction can be improved, and the intelligent delivery of the second control information can be further carried out by relying on the change trajectory of the position. For example, the voice volume, the light intensity, and the projection range or the like are adjusted according to the running range of the pet.

The position of the pet can be determined by any one or even a combination of the device worn by the pet, the real-time position trajectory, and the visual (camera) capture.

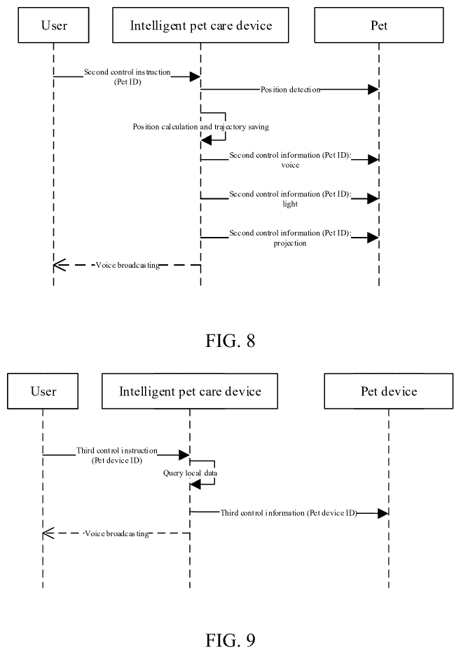

The bark collar worn around the neck of the pet or all other circuit devices related to the living environment of the pet (air conditioners, feeders, speakers, etc.) can all be controlled. A typical scenario is shown in FIG. 8, which specifically includes the following steps:
1. inputting a second control instruction with a pet ID to an intelligent pet care device by the user;
2. starting position detection by the intelligent pet care device to detect the position of the pet;
3. performing position calculation and saving the movement trajectory of the pet by the intelligent pet care device;
4. sending corresponding information to the position where the pet is located, including voice, light, projection or the like; and
5. performing voice broadcasting to the user by the intelligent pet care device, and feeding back control result status or the like.

Referring to FIG. 3, the method further comprises the following steps:
S5: receiving a third control instruction; and
S6: sending third control information to a pet device according to the third control instruction;
the third control information is sent by one of the following: infrared, radio frequency and Bluetooth;
wherein the third control instruction comprises a unique identifier of the pet device. The radio frequency may include 5G, 2.4G, Bluetooth, or the like.

As can be seen from the above description, the intelligent pet care device realizes the purpose of forwarding control information to the pet device from the intelligent pet care device so as to control the pet device to perform related operations through Bluetooth, infrared and other short-distance low-cost communication modes, thereby achieving the purpose of multi-directional and multi-dimensional care control.

The pet devices include but are not limited to: devices worn by pets, such as collars and trackers or the like; pet-feeding related devices, such as feeders, water feeders, defecation devices or the like; pet sports equipment, such as electric toys that can interact with dogs, and sports training equipment; and various environmental devices in the living space of pets, such as humidifiers, air conditioners or the like. A typical scenario is shown in FIG. 9, which specifically includes the following steps:
1. inputting a third control instruction with a pet ID to the intelligent pet care device by the user;
2. querying the local data according to the third control instruction by the intelligent pet care device so as to acquire the respective identification and other information of the corresponding pet device;
3. sending third control information to the corresponding pet device by the intelligent pet care device so as to control the corresponding pet device to make corresponding operations;
4. performing voice broadcasting to users and feeding back the control result status or the like by the intelligent pet care device.

The way in which the intelligent pet care device responds to users is not limited to voice broadcasting, and instead, it may also include multiple dimensions such as video display, UI interface display and projection.

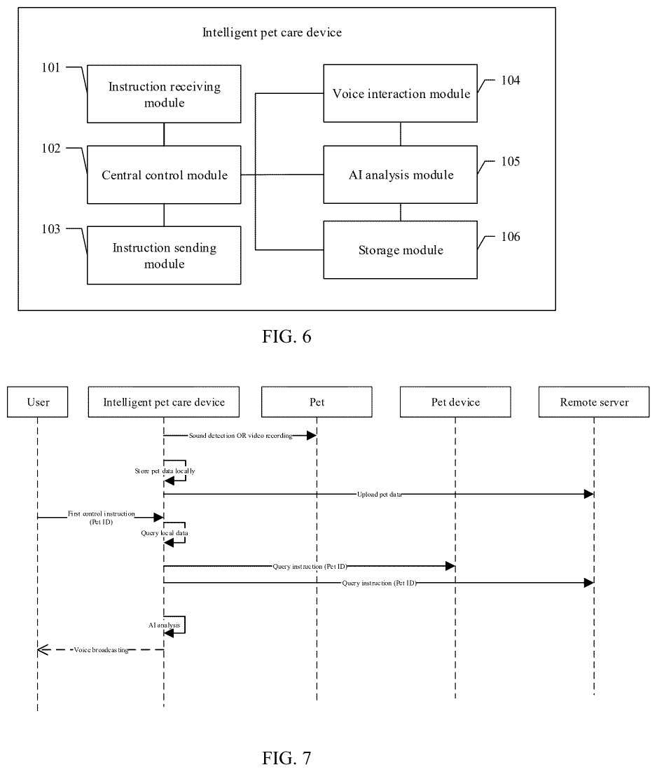

In another aspect, referring to FIG. 6, the present disclosure provides an intelligent pet care device, which includes:
an instruction receiving module 101, an instruction sending module 103, a central control module 102, an AI analysis module 105, a voice interaction module 104 and a storage module 106; wherein the instruction receiving module 101 is configured to receive control instructions; the instruction sending module 103 is configured to send control information; the storage module 106 is configured to store pet information and/or audio and video information about interaction with the pet; the AI analysis module 105 is configured to perform AI analysis according to the input original data so as to acquire pet information; the voice interaction module 104 is configured to convert the pet information into audio and play the audio, and the central control module 102 is configured to control the cooperation among the instruction receiving module 101, the instruction sending module 103, the AI analysis module 105, the voice interaction module 104 and the storage module 106.

Based on the same inventive concept, reference is made to the above embodiment for the specific interaction flow between various modules, and this will not be further described herein.

In a further aspect, the present disclosure provides an intelligent pet care device, which comprises a memory and a processor coupled with each other, and the processor is configured to execute program instructions stored in the memory to implement the intelligent pet care method according to any of the aforesaid items.

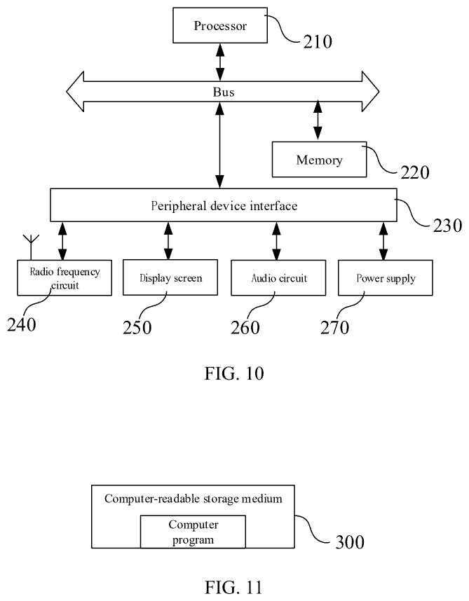

Specifically, referring to FIG. 10, the intelligent pet care device described in the embodiment of the present disclosure may specifically include a processor 210 and a memory 220. The memory 220 is coupled to the processor 210.

The processor 210 is used to control the operation of the intelligent pet care device, and the processor 210 may also be called a Central Processing Unit (CPU). The processor 210 may be an integrated circuit chip with signal processing capability. The processor 210 may also be a general-purpose processor, a digital signal processor (DSP), an application specific integrated circuit (ASIC), a field programmable gate array (FPGA) or other programmable logic devices, a discrete gate or a transistor logic device, and a discrete hardware component. The general-purpose processor may be a microprocessor or the processor 210 may be any conventional processor or the like The memory 220 is used to store computer programs, and it may be a RAM, a ROM or other types of storage devices. Specifically, the memory may include one or more computer-readable storage media, which may be non-transitory. The memory may also include a high-speed random access memory and a non-volatile memory, such as one or more disk storage devices and flash memory storage devices. In some embodiments, the non-transitory computer-readable storage medium in the memory is used to store at least one program code.

The processor 210 is used to execute the computer program stored in the memory 220 so as to implement the method described in the method embodiments of the present disclosure.

In some embodiments, the intelligent pet care device may further include a peripheral device interface 230 and at least one peripheral device. The processor 210, the memory 220 and the peripheral device interface 230 may be connected with each other by a bus or a signal line. Each peripheral device may be connected to the peripheral device interface 230 through a bus, a signal line or a circuit board. Specifically, the peripheral device includes at least one of a radio frequency circuit 240, a display screen 250, an audio circuit 260 and a power supply 270.

The peripheral device interface 230 may be used to connect at least one peripheral device related to Input/output (I/O) to the processor 210 and the memory 220. In some embodiments, the processor 210, the memory 220 and the peripheral device interface 230 are integrated on the same chip or circuit board. In some other embodiments, any one or two of the processor 210, the memory 220 and the peripheral device interface 230 may be implemented on separate chips or circuit boards, which is not limited by this embodiment.

The radio frequency circuit 240 is used to receive and transmit Radio Frequency (RF) signals, which are also called electromagnetic signals. The RF circuit 240 communicates with the communication network and other communication devices through electromagnetic signals, and the RF circuit 240 is the communication circuit of the intelligent pet care device. The RF circuit 240 converts an electrical signal into an electromagnetic signal for transmission, or converts a received electromagnetic signal into an electrical signal. Optionally, the RF circuit 240 includes an antenna system, an RF transceiver, one or more amplifiers, a tuner, an oscillator, a digital signal processor, a codec chipset, a subscriber identity module card, and the like. The RF circuit 240 may communicate with other terminals through at least one wireless communication protocol. The wireless communication protocol includes, but is not limited to, World Wide Web, Metropolitan Area Network (MAN), Intranet, mobile communication networks of various generations (2G, 3G, 4G and 5G), wireless local area network (WLAN) and/or Wireless Fidelity (WiFi) network. In some embodiments, the RF circuit 240 may also include a circuit related to Near Field Communication (NFC), which is not limited in the present disclosure.

The display screen 250 is used to display a User Interface (UI). The UI may include graphics, text, icons, videos and any combination thereof. When the display screen 250 is a touch display screen, the display screen 250 is also capable of collecting touch signals on or above the surface of the display screen 250. The touch signal may be input as a control signal to the processor 210 for processing. At this time, the display screen 250 can also be used to provide virtual buttons and/or virtual keyboards, which are also called soft buttons and/or soft keyboards. In some embodiments, there may be one display screen 250, which is arranged on the front panel of the intelligent pet care device. In some other embodiments, there may be at least two display screens 250, which are respectively arranged on different surfaces of the intelligent pet care device or designed in a folded form. In some other embodiments, the display screen 250 may be a flexible display screen disposed on a curved surface or a folded surface of the smart pet care device. Even, the display screen 250 may also be provided in a non-rectangular irregular pattern, that is, the display screen 250 is provided as a special-shaped screen. The display screen 250 may be made of materials such as Liquid Crystal Display (LCD) and Organic Light Emitting Diode (OLED).

The audio circuit 260 may include a microphone and a speaker. The microphone is used to collect sound waves from users and the environment, and convert the sound waves into electrical signals and input the electrical signals to the processor 210 for processing, or input the electrical signals to the RF circuit 240 for voice communication. For the purpose of stereo collection or noise reduction, there may be multiple microphones, which are respectively arranged on different parts of the intelligent pet care device. The microphone may also be an array microphone or an omni-directional acquisition microphone. The speaker is used to convert electrical signals from the processor 210 or the RF circuit 240 into sound waves. The speaker may be a traditional thin film speaker or a piezoelectric ceramic speaker. When the speaker is a piezoelectric ceramic speaker, it can not only convert electrical signals into sound waves audible to humans, but also convert electrical signals into sound waves inaudible to humans for ranging and other purposes. In some embodiments, the audio circuit 260 may also include an earphone jack.

The power supply 270 is used to supply power to various components in the intelligent pet care device. The power supply 270 may be alternating current, direct current, a disposable battery or a rechargeable battery. When the power supply 270 includes a rechargeable battery, the rechargeable battery may be a wired rechargeable battery or a wireless rechargeable battery. The wired rechargeable batteries are batteries charged by wired lines, while the wireless rechargeable batteries are batteries charged by wireless coils. The rechargeable battery may also be used to support the fast charging technology.

For a detailed description of the functions and execution process of various functional modules or components in the embodiments of the intelligent pet care device according to the present disclosure, reference may be made to the description in the above-mentioned method embodiments of the present disclosure, and this will not be further described herein.

In several embodiments provided according to the present disclosure, it should be understood that the disclosed intelligent pet care device and method can be realized in other ways. For example, the embodiments of the intelligent pet care device described above are only schematic. For example, the division of modules or units is only a logical function division, and in actual implementation, there may be other division methods. For example, multiple units or components may be combined or integrated into another system, or some features may be ignored or not executed. On the other hand, the mutual coupling or direct coupling or communication connection shown or discussed may be indirect coupling or communication connection achieved through some interfaces, devices or units, and it may be electrical, mechanical or other forms of coupling or connection.

The units described as separate components may be or may not be physically separate, and the components shown as units may be or may not be physical units, and may be co-located at a same place or distributed over multiple network units. A part of or all of the units may be selected depending on the actual need to achieve the objective of the solution of the present embodiments.

In addition, each functional unit in each embodiment of the present disclosure may be integrated into one processing unit, or each unit may exist physically alone, or two or more units may be integrated into one unit. The above integrated units can be realized in the form of both hardware and software functional units.

In another aspect, the present disclosure provides an intelligent pet care system, which comprises a pet device and the intelligent pet care device described above.

In a further aspect, the present disclosure provides a computer-readable storage medium, in which a computer program is stored, and the computer program can be executed by a processor to implement the method according to any of the above items.

Referring to FIG. 11, if the above integrated units are realized in the form of software functional units and sold or used as independent products, they can be stored in a computer-readable storage medium 300. Based on this understanding, the technical solution of the present disclosure, in essence or in part that contributes to the prior art, or the whole or part of the technical solution can be embodied in the form of computer software products, and the computer software products are stored in a storage medium and include several instructions/computer programs to make an intelligent pet care device (which may be a personal computer, a server, or a network device, etc.) or a processor execute all or part of the steps of the methods of various embodiments of the present disclosure. The aforementioned storage medium includes various media such as a USB flash disk, a mobile hard disk, a Read-Only Memory (ROM), a Random Access Memory (RAM), a magnetic disk or an optical disk, and electronic devices with the above storage media, such as a computer, a mobile phone, a notebook computer, a tablet computer and a camera.

For the description of the execution process of program data in the computer-readable storage medium, reference may be made to the description of the above-mentioned method embodiments of the present disclosure, and this will not be further described herein.

What described above are only the embodiments of the present disclosure, but are not intended to limit the scope of the present disclosure. Any equivalent structures or equivalent process flow modifications that are made according to the specification and the attached drawings of the present disclosure, or any direct or indirect applications of the present disclosure in other related technical fields shall all be covered within the scope of the present disclosure.

As shall be appreciated by those skilled in the art, in the above-mentioned method of the specific embodiments, the order in which each step is written does not mean strict execution order to constitute any limitation on the implementation process, and the specific execution order of each step should be determined according to its function and possible inherent logic.

According to the above descriptions, the present disclosure has the following beneficial effects: the intelligent pet care method provided according to the present disclosure is provided on the intelligent pet care device in a dog-keeping space, and it is used to receive the first control instruction, and query according to the first control instruction to acquire the pet information, and then convert the pet information into audio to be played. In this way, users (e.g., pet owners, breeders or the like) can immediately know various conditions of their pets without turning on their mobile phones or carrying out complicated network operations, so as to make timely judgments and responses and improve the convenience and accuracy of acquiring pet information by users.

Furthermore, according to the instructions of the user, multiple interactions between the intelligent pet care device and the pet can be realized. For example, information is send to the position where the pet is located in various ways, such as by voice, light and projection, thereby achieving the effect of intelligent companionship.

Further speaking, according to the instructions of the user, the purpose of forwarding the control information to the pet device through the intelligent pet care device so as to control the pet device to perform related operations can also be realized, thereby achieving multi-directional and multi-dimensional care control.

1. An intelligent pet care method, being characterized in that, comprising the following steps:
receiving a first control instruction, and querying according to the first control instruction to acquire pet information;
converting the pet information into audio and playing the audio;
wherein the first control instruction comprises a unique identifier of the pet.

2. The intelligent pet care method according to claim 1, being characterized in that, the step of querying according to the first control instruction to acquire pet information includes one of the following querying modes: querying the stored data locally, querying the remotely stored data from a remote server, and sending an instruction to other pet devices to query the real-time data.

3. The intelligent pet care method according to claim 1, being characterized in that, the pet information includes key data of the pet in a specific time interval, and the step of receiving the first control instruction further comprises: extracting keywords after semantic analysis according to the first control instruction, and then calculating according to the keywords to acquire the specific time interval.

4. The intelligent pet care method according to claim 1, being characterized in that, the pet information includes one of the following: pet feeding data, pet defecation data and pet calling data.

5. The intelligent pet care method according to claim 4, being characterized in that, further comprising the step of:
carrying out pet calling statistics to form and store the pet calling data.

6. The intelligent pet care method according to claim 5, being characterized in that, the pet calling statistics further comprises the steps of:
performing sound detection to acquire the sound of the pet; and
performing AI analysis on the sound of the pet to acquire the pet calling data.

7. The intelligent pet care method according to claim 5, being characterized in that, the pet calling statistics further comprises the steps of:
recording a video to acquire the video of the pet;
performing AI analysis on the video of the pet to acquire the pet calling data.

8. The intelligent pet care method according to claim 4, being characterized in that, further comprising the step of:
carrying out pet defecation statistics to form and store the pet defecation data.

9. The intelligent pet care method according to claim 8, being characterized in that, the pet defecation statistics further comprises the steps of:
recording a video to acquire the video of the pet; and
performing AI analysis on the video of the pet to acquire the pet defecation data.

10. The intelligent pet care method according to claim 8, being characterized in that, the pet defecation statistics further comprises the step of:
communicating with a pet device to acquire the defecation data of the pet, wherein the pet device includes a device worn on the pet and a defecation device.

11. The intelligent pet care method according to claim 4, being characterized in that, further comprising the step of:
carrying out pet feeding statistics to form and store the pet feeding data.

12. The intelligent pet care method according to claim 11, being characterized in that, the pet feeding statistics further comprises the step of:
communicating with a pet device to acquire the feeding data of the pet, wherein the pet device includes a device worn on the pet, a feeder and a water feeder.

13. The intelligent pet care method according to claim 1, being characterized in that, further comprising the steps of:
receiving a second control instruction, and sending second control information to the position where the pet is located according to the second control instruction;
the second control information is sent by one of the following: voice, light and projection;
wherein the second control instruction comprises a unique identifier of the pet.

14. The intelligent pet care method according to claim 13, being characterized in that, the step of sending second control information to the position where the pet is located according to the second control instruction further comprises the steps of:
starting position detection for the pet, calculating to determine the position of the pet according to the result of the position detection for the pet, and recording and storing the change trajectory of the position.

15. The intelligent pet care method according to claim 1, being characterized in that, further comprising the steps of:
receiving a third control instruction and sending third control information to a pet device according to the third control instruction;
the third control information is sent by one of the following: infrared, radio frequency and Bluetooth;
wherein the third control instruction comprises a unique identifier of the pet device.

16. The intelligent pet care method according to claim 1, being characterized in that, the control instruction is input by one of the following: voice input, camera-captured picture input, touch screen input, mechanical key input and remote communication input.

17. An intelligent pet care device, being characterized in that, comprising:
an instruction receiving module, an instruction sending module, a central control module, an AI analysis module, a voice interaction module and a storage module; wherein the instruction receiving module is configured to receive control instructions; the instruction sending module is configured to send control information; the storage module is configured to store pet information and/or audio and video information about interaction with the pet; the AI analysis module is configured to perform AI analysis according to the input original data so as to acquire pet information; the voice interaction module is configured to convert the pet information into audio and play the audio, and the central control module is configured to control the cooperation among the instruction receiving module, the instruction sending module, the AI analysis module, the voice interaction module and the storage module.

18. An intelligent pet care device, being characterized in that, comprising a memory and a processor coupled to each other, wherein the processor is configured to execute program instructions stored in the memory so as to implement the intelligent pet care method according to claim 1.

19. An intelligent pet care system, being characterized in that, comprising a pet device and the intelligent pet care device according to claim 17.

20. A computer-readable storage medium having program instructions stored thereon, being characterized in that, the program instructions, when executed by a processor, implement the intelligent pet care method according to claim 1.
